(19) United States
(12) Patent Application Publication
(10) Pub. No.: US 2007/0288966 A1
(43) Pub. Date: Dec. 13, 2007

(54) Method and system for personalized media players

(76) Inventors: Sasha Javid, Boston, MA (US); Devasenapathi Seetharamakrishnan, Medford, MA (US); Stephanie Norton, Boston, MA (US)

Correspondence Address: Shivani Kaul, Esq.;Brown Rudnick Berlack Israels LLP, One Financial Center, Boston, MA, 02111, US

(21) Appl. No.: 11/724,103

(22) Filed: Mar. 14, 2007

Related U.S. Application Data
(60) Provisional application No. 60/788,904, filed on Apr. 4, 2006.

(51) Int. Cl. H04N 7/173

(52) U.S. Cl. 725/46

(57) ABSTRACT

A method and a system for managing and utilizing personalized media preferences. The method includes establishing a plurality of user preferences, the preferences specifying at least one media type and at least one preferred programming content. The method also includes storing the user preferences on a portable storage device, and reading the stored plurality of user preferences, wherein the preferences affect the programming content played by the media player, wherein the programming content is a multimedia content.

### RELATED APPLICATION INFORMATION

This patent application takes the priority of U.S. Provisional Application No. 60/788,904, filed in the U.S. Patent and Trademark Office on Apr. 4, 2006. The entire contents are incorporated herein by reference.

### FIELD OF THE INVENTION

This invention relates to, in general, an apparatus, system, method and computer program product for delivery of services to users, and in particular to an apparatus, system, method and computer program product for delivery of personalized and customized multimedia and data content to digital radio users.

### BACKGROUND OF THE INVENTION

Due to advances in computing and communication technologies, the media industry is moving towards three powerful innovations:
1. Digital content—media content is moving toward digital format. More importantly, media content is or will soon be tagged with meta information (such as ID3 and SMIL tags) that describe content so that it can be searched, analyzed and processed by computing devices.
2. Unification of media—due to the advent of interoperable networked devices and service and device discovery technologies such as ZeroConf, UPnP (universal plug and play) and DLNA (Digital Living Network Alliance), distinction between different media devices is disappearing. For example, a laptop computer can stream videos downloaded from the Internet to a television for viewing the program on a large screen.
3. High-capacity communication channels—due to widespread availability of high-capacity digital networks (such as DSL, cable, T1, 3G etc.) the volume of content that is distributed is increasing exponentially.

An average user is inundated with hundreds of channels and programs from a variety of content sources such as radio, Internet and television. Users need novel tools to find and consume content that they find useful and interesting. Conventional program guides are not able to fulfill this need because they suffer one or more of the following shortcomings:
1. Disparate guides—each type of media has a separate guide and users cannot search for contents across different media. For example, a guide for television programs does not include any information about radio broadcasts.
2. Static listings—usually program guides are neither searchable nor customizable. The programs are presented as static grids (time vs. channel) that present a scrolling list of programs in chronological order.
3. No user model—usually program guides do not consider user preferences and present programs without any consideration for users' likes and dislikes. For example, a user might not be interested in sports channels however, conventional program guides would list sports channels in the program listings.
4. No recommendation mechanism—conventional program guides only present a list of programs. They do not recommend any new content that might be of interest to users. Recommender systems are beneficial since they can help users find new programs that match their interests but would otherwise be unknown to them.

‘A Universal Program Guide’, U.S. patent application Ser. No. 11/713,318 (the '318 Application), filed in March 2007 claiming priority to Provisional Application No. 60/778,895 filed in March 2006, addresses a need for better navigation guides. According to the '318 Application, unlike conventional program guides, user preferences are used to personalize the program guides. For example, if a user prefers only classic rock and jazz music on digital radio, the program-guide listings will be formed only from these two types of programs. User interfaces are employed to elicit user preferences.

Another example of a personalized guide is The UGuide™ (http://www.gist.com/), a guide product from Gist Communications. It is a ubiquitous, mobile utility service that enables users to use mobile phones to receive personalized content recommendations, to search for favorite programs and to view television program guides. A limitation of the Gist Communications' product is that it requires the user to manually search for their favorite programs and then uses this information to tune the television because the program information sitting on the mobile phone is not networked to the television that actually plays the content.

Liliana Ardissono et. al. ‘User Modeling and Recommendation Techniques for Personalized Electronic Program Guides’ teaches a system that generates personalized Electronic Program Guides for Digital TV. This system is shown in FIG. 1. Users of diverse profiles provide feedback 120 on various offline/online multimedia content 110. The classifier 130 matches the user profiles to the ranked content, and generates learning rules. The ranks of contents with corresponding profile attributes are stored in the profile based clustered content server 150. For a new user, the user profile 140 is entered into the content classification and filtering system 160. The content classification and filtering system 160 based on the new user profile 140 checks the clustered content server 150 for the highest rank program types for the given profile, and then selects the matching programs 170. The media player 180 downloads and then plays the selected programs 170.

In U.S. Patent Application No. 20060200413 (the '413 Application), techniques are described providing consumers with devices on which digital content appropriate for those consumers has been loaded. In some situations, when a consumer orders a digital media player 180 or other consumer device from a merchant (or other distributor of the device), the merchant preloads the device 180 with a copy of the suggested digital media content 170 before delivering that device to the consumer or other specified recipient, such as digital media items that are automatically selected in a personalized manner for the recipient to whom the device will be sent. This approach described in the '413 Application has several limitations. Firstly, because the suggested media content 170 has to be loaded onto the device 180, there is no mechanism to filter content that is received in real-time by the device 180 such as live digital radio broadcasts. Another shortcoming of the '413 Application is that it does not provide for a feedback mechanism directly on the device 180. Thus, information such as which songs are played most frequently on the device 180 is not captured. This feedback can further refine user preferences with up-to-date information.

In U.S. Patent Application No. 20060195516 (the '516 Application), a system and method of generating a play list of affinity related media files using affinity relationship data is described. The relationship affinity data is based upon a user rating score obtained from a population of user's ratings associated with media file attributes. A media file attribute including an artist, an album, a title, and genre information associated with a media file is received from the user, indicating the user's desire to create an affinity play list of media files having an affinity relationship based upon the selected media file attribute.

U.S. Patent Application No. 20060195516 (the '516 Application) discloses a method for providing personalized content to a user. If the personalized replacement content is determined to be more appropriate than the primary content, based upon personalization parameters, the primary content is substituted with the personalized replacement content. The approach defined in the '516 Application does not, however, allow for the filtering of content from live broadcasts whose programming is not known in advance. Another limitation of the '516 Application is that it does not utilize environment sensors such as microphones and accelerometers on the mobile device 180 to customize the media content 170. For example, if the mobile device 180 has an accelerometer, it can identify that the end user is moving and that the media content 170 needs to be enlarged to make it more legible.

In U.S. Patent Application No. 20020026459 (the '459 Application), customized information guides are generated. A questionnaire is used by information-recipients to describe their preferences. User preferences along with available information about a specific location are used to automatically create a personalized information guide. One limitation with the '459 Application is that it requires end user intervention to create and maintain the user profile 140. Creating preferences by scanning stored MP3 files or updating preferences based on actual listening or watching habits is not addressed in the '459 Application. Instead, the '459 Application requires users to fill out questionnaires. This can be burdensome on the end user, particularly to keep the profile 140 current.

In U.S. Patent Application No. 20060235864 (the '864 Application), techniques for facilitating a purchase of media items, such as digital media assets, are disclosed. A portable media player may be coupled to a media system within a vehicle or other environment such that one or more digital media assets being presented by the media system may be tagged. After a digital media asset has been tagged, the portable media player may be removed from the vehicle or other environment and coupled to an electronic commerce environment. The electronic commerce environment facilitates the purchase of the digital asset that has been tagged. This work also includes at least the acts of receiving, at a server computer, an audio sample from a client computer, identifying at least one media asset associated with the audio sample, receiving a request to purchase the identified media asset, processing a payment for the identified media asset, and delivering the one or more identified media assets to the client computer. This process defined in the '864 Application may be very inefficient because sending audio samples requires a great deal of bandwidth and often results in false program identifications.

### SUMMARY OF THE INVENTION

In an embodiment of the present invention, a method of managing and utilizing personalized media preferences is disclosed. The method includes establishing a plurality of user preferences, storing the plurality of user preferences on a portable storage device, and reading the stored plurality of user preferences. The preferences affect the programming content played by the media player.

In another embodiment of the present invention, the user preferences are established over a computer network.

In yet another embodiment of the present invention, a system for managing and utilizing personalized media preferences is disclosed. The system includes a plurality of user preferences, a portable storage device, and a media player. The portable storage device stores the user preferences and the media player reads the stored preferences.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein like reference numerals designate identical or corresponding parts throughout the several views, and:

FIG. 1 is an illustration of methods for the personalization of multimedia content;

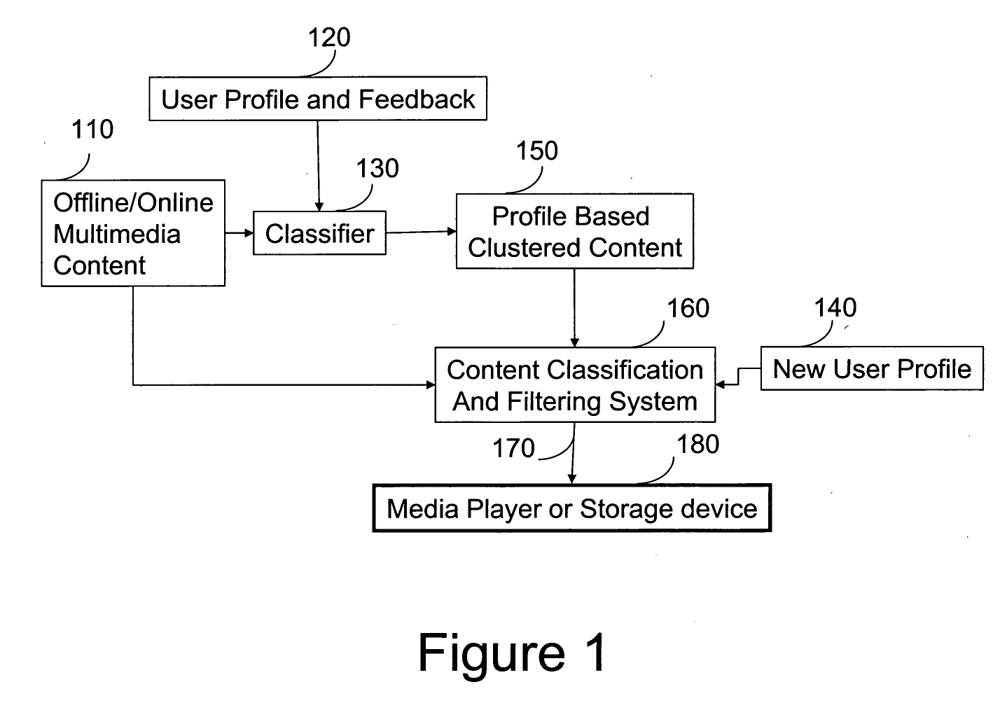

FIG. 2 is a block diagram of the personalized multimedia delivery system according to the present invention;

FIG. 3 is a high-level block diagram of the media player according to the present invention; and

FIG. 4 is an illustration of how user preferences may be manipulated according to location, time, context and environment.

### DETAILED DESCRIPTION OF THE PREFERRED EMBODIMENTS

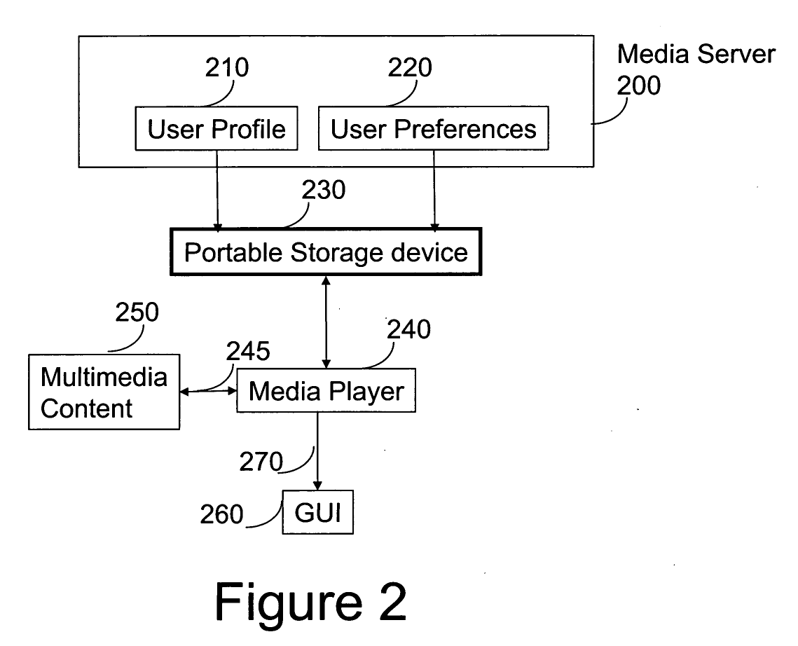

According to the invention, as illustrated in FIG. 2, user preferences 220 and user profiles 210 stored on the media server 200 are transferred via a portable storage device 230 to a media player 240. Generally, the media player only receives the suggested content and plays it, or the storage device is loaded directly with the multimedia content. However, according to an embodiment of the present invention, the media player 240 filters all the available multimedia content 250 according to user profile 210 and preferences 220, and plays only the content that matches user preferences 220. The media player 240 also sends the personalized media guide 270 to the Graphical User Interface (GUI) 260. For example, by employing a portable storage device 230 containing his or her preferences 220, a user can customize a digital radio in a rental car or personalize a television in a hotel room. Once user preferences 220 are transferred to a media player 240, that appliance can operate in autopilot mode to play programs that best fits users' interests without any intervention from the users themselves or without the need for a published guide of upcoming programming. This autopilot mode is not only convenient, but it allows users to pay attention to more important tasks. For example, a car radio operating in autopilot mode may make driving safer since the driver can focus on the road and not on tuning the radio.

The system can expand its model of user preferences from media-guide server recommendations (obtained in accordance with, for example, the '318 Application), further elicitations, user feedback and environment sensor feedback.

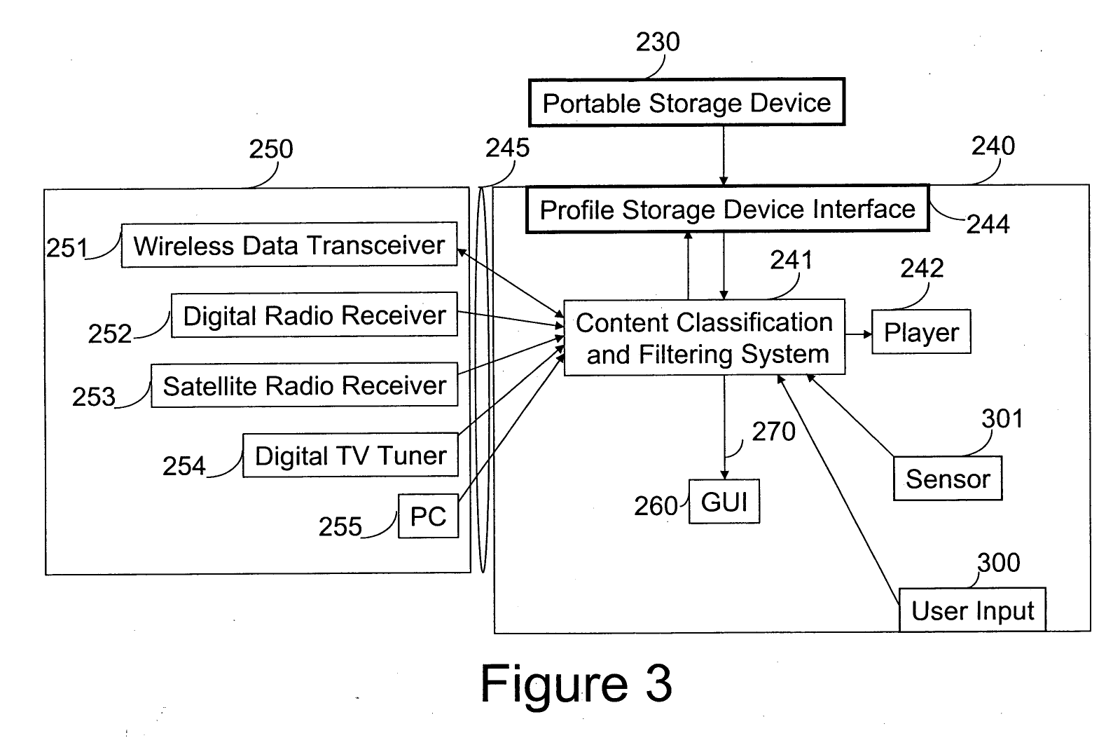

As shown in FIG. 3, the media player 240 includes a profile storage device interface 244 with which it reads the contents of portable storage device 230 to obtain user preferences 220, content classification and filtering system 241, GUI 260 and player unit 242. Alternatively, the preferences 220 may be downloaded directly onto the media player 240 from the media server 200 without intermediate storage on a storage device 230. For example, the media player 240 may be a portable device that docks to a client computer (PC) 255 by accessing the media server 200 via the internet. The client computer (PC) 255 may facilitate the download of server-stored preferences directly onto the device. The multimedia content 250 may include content from wireless data transceiver 251 (e.g. a WiFi Network Card), digital radio receiver 252, satellite radio receiver 253, digital TV tuners 254 or client computers 255, among other things.

The media player may use the retrieved user preferences 220 to guide searches for filtering and classifying 241 appropriate programs. The player 242 plays the programs that match user preferences 220. Also, the guide of the selected program 270 is sent to the GUI 260. The storage reader interface 244 and the storage device 230 may be compatible with each other. For example, in a rental-car, a person carrying his user preferences on a storage device such as a NFC tag or USB memory key can load these onto the digital radio in the rental car so long as the digital radio is equipped with a proper reader or an adapter that can read the user's storage device. The player employs these user preferences to generate customized electronic program guides or automatic program selections (in autopilot mode) that are to be displayed on the GUI 260.

In another embodiment according to the present invention, the media player 240 has connectivity 245 via a wireless data transceiver 251 to the internet. In this case, the media player 240 directly gathers user preferences 220 from the multimedia server 200 over the network connection. The server 200 performs content selection directly by itself and transfers this tuning instruction automatically to the media player 240. The server 200 may also manipulate via commands the content of the media player 240 including when to play and what to play.

According to the present invention, as illustrated in FIG. 3, the media player 240 is equipped with an appropriate writer that may collect further information via the user input 300 about the user's preferences. For example, if a user likes the recommended program the user may express approval thereof by entering a positive input 300. That information 300 may be written back to the storage device 230 to update user preferences 220 and make them more accurate. On the other hand, if the user does not like the program, the user may enter a negative feedback to express disapproval. The user's feedback may be recorded on the storage device 230 to add more information to the user preferences 220. This information may, for example, be uploaded from the storage device 230 to the media server 200. Accordingly, the system may expand its model of user preferences 220 by acquiring feedback from the user.

The media player 240 is also equipped with sensors 301 and an appropriate writer that may collect further information via the sensors 301 about the user's preferences based on the environment. For example, if a sensor 301 such as a microphone identifies ambient sounds such as the user talking on the phone, the volume on the media player 240 will be automatically turned down. The Location Information 410 may be used to select appropriate content. For example, if the user is in a gym, the user may prefer to listen to fast paced music; on the other hand, if the user is at a work environment, slow music may be the music of choice. Another sensor 301, such as an output of a light sensor, may identify that the environment is dark and that the GUI 260 needs to be brightened to make reading the display easier while the user is in the dark.

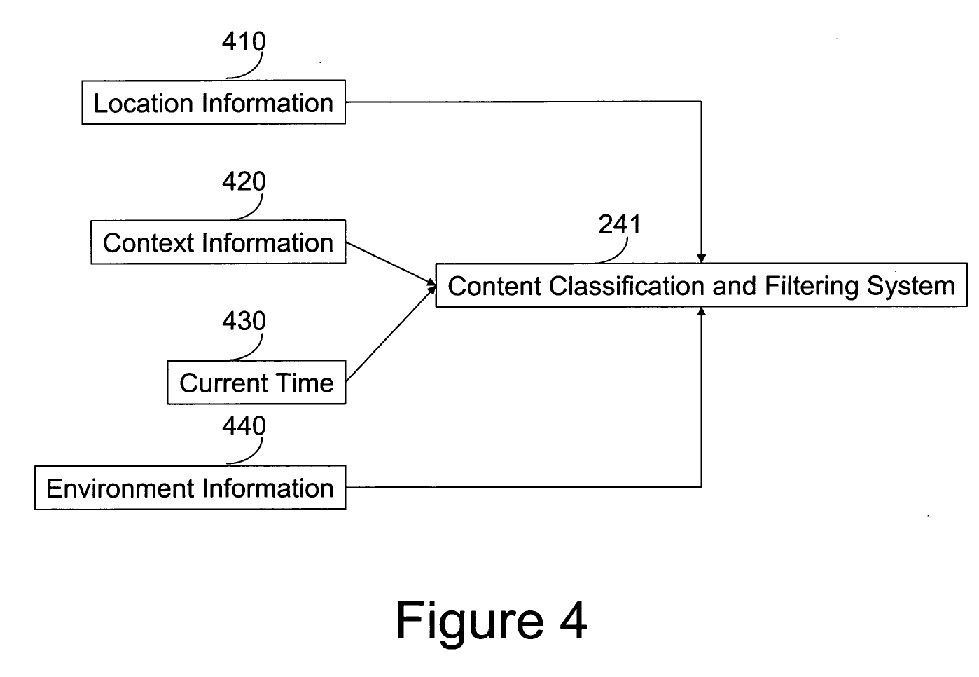

Accordingly, the system may expand its model of user preferences 220 by acquiring feedback from the user 300 as well as feedback from sensors 301 on the media player 240. User preferences 220 may be classified and stored as a function of user location 410, current time 430, context of the situation information 420, and environment information 440, as illustrated in FIG. 4.

In various embodiments, according to the present invention, the personalized media player includes any or all of the following components and features:
A networked client (typically, a media server 200 or networked PC connected to the media server 255) that may collect and store user preferences 220 and user profiles 210, and writes the user preferences 220 onto a portable storage device 230. This network client may also upload additional information about user preferences 220 from user input 300 and sensors 301 taken off the portable storage device 230.
A media player unit 240 with writing capability onto the storage device 230.
Non-networked media players 240 equipped with suitable readers may read the storage devices to learn user preferences 220. The players may use those preferences to develop customized electronic program guides and to classify, filter 241 and guide their search for appropriate programs that are played for the user.

While the present invention and its embodiments have been described in detail, it will be apparent to those skilled in the art that the principles of the invention are readily adaptable to other implementations and system configurations and communications paradigms without departing from the scope and spirit of the invention, as defined by the following claims.

1. A method of managing and utilizing personalized media preferences, the method comprising:
a. establishing a plurality of user preferences, the preferences specifying at least one media type and at least one preferred programming content;
b. storing the plurality of user preferences on a portable storage device; and
c. reading the stored plurality of user preferences, wherein the preferences affect the programming content played by the media player, wherein the programming content is a multimedia content.

2. The method of claim 1, wherein the user preferences are established over a computer network.

3. The method of claim 1, wherein the multimedia content played by the media player is locally-stored content downloaded by the user or a live broadcast and a live streaming content received in real-time by the media player, wherein the programming is not determined by the user, and is not published in advance.

4. The method of claim 1, wherein a source of the multimedia content is a digital radio broadcast.

5. The method of claim 1, wherein a customization, filtering and tuning of the multimedia content is done at a server residing in a computer network.

6. The method of claim 1 further comprising receiving user feedback relating to currently playing content that contributes to the user preferences by the media player.

7. The method of claim 1 further comprising receiving sensor input concerning an environment of the user that contributes to the user preferences by the media player.

8. The method of claim 1 further comprising using user and sensor feedback to alter the user preferences.

9. The method of claim 1 further comprising altering the user preferences depending on user environment, location, context of the situation and current time.

10. The method of claim 5 wherein the server is connected to the media player via wired or wireless connection.

11. A system for managing and utilizing personalized media preferences, the system comprising:
a. a plurality of user preferences, the preferences specifying at least one media type and at least one preferred programming content;
b. a portable storage device for storing the user preferences; and
c. a media player for reading the stored preferences, wherein the preferences affect the programming content played by the media player, wherein the programming content is multimedia content.

12. The system of claim 11, wherein the user preferences are established over a computer network.

13. The system of claim 11, wherein the multimedia content played by the media player is locally-stored content downloaded by the user or a live broadcast and a live streaming content received in real-time by the media player, and wherein the programming is not determined by the user, and is not published in advance.

14. The system of claim 11, wherein the source of the multimedia content is a digital radio broadcast.

15. The system of claim 11, wherein the customization, filtering and tuning of multimedia content is done at a server residing in a computer network.

16. The system of claim 11, wherein the media player receives user feedback relating to currently playing content that contributes to the user preferences.

17. The system of claim 11 wherein the media player receives sensor input concerning the environment of the user that contributes to the user preferences.

18. The system of claim 11 further comprising user and sensor feedback to alter the user preferences.

19. The system of claim 11 further comprising the user preferences altered depending on user environment, location, context of the situation and current time.

20. The system of claim 15 wherein the server is connected to the media player via wired or wireless connection.
